(19) United States
(12) Patent Application Publication
(10) Pub. No.: US 2019/0226615 A1
(43) Pub. Date: Jul. 25, 2019

(54) Joint Assembly

(71) Applicants: ZHANGZHOU LEYUAN INDUSTRIAL CO., LTD., Zhangzhou City (CN); DONGGUAN JIAXUAN HARDWARE & PLASTIC CO., LTD., Dongguang City (CN)

(72) Inventors: Hai-Jun Wu, Dongguang City (CN); Xue-Ping Zhao, Dongguang City (CN)

(21) Appl. No.: 16/188,688

(22) Filed: Nov. 13, 2018

(30) Foreign Application Priority Data
Jan. 25, 2018 (CN) 201820126045.7

(51) Int. Cl. F16L 33/22; F16L 33/01; F16L 33/18

(52) U.S. Cl. CPC F16L 33/224; F16L 19/0206; F16L 33/18; F16L 33/01

(57) ABSTRACT

A joint is devised for connection to an internal tube of a longitudinally extensible hose. The joint includes a sleeve and a tubular insert. The sleeve includes an axial channel for receiving the internal tube. The axial channel includes a diameter-wise smaller section and a diameter-wise larger section. The tubular insert is inserted in the internal tube so that the tubular insert and the sleeve clamp the internal tube. The tubular insert includes an axial passageway, an annular bulge and an annular flange. The axial passageway extends coaxially with the axial channel. The annular bulge is formed on a middle section of the tubular insert and adapted for pressing the internal tube against an wall of the diameter-wise larger section of the axial channel. The annular flange is formed at an end of the tubular insert and adapted for contact with an end of the sleeve.

### BACKGROUND OF INVENTION

### 1. Field of Invention

The present invention relates to a hose and, more particularly, a joint assembly for interconnecting two hoses.

### 2. Related Prior Art

Longitudinally extensible hoses are popular for gardening and cleaning for example. Longitudinally extensible hoses automatically extend longitudinally due to water pressure in use, and this is convenient. A longitudinally extensible hose includes an elastic internal tube, a woven external tube, and a connecting unit for connecting an end of the internal tube to an end of the external tube. The joint includes a tubular element, an elastic sleeve and a ring. The tubular element is partially inserted in the internal tube. The elastic sleeve is provided around the external tube. The ring is provided around the elastic sleeve. The joint can be connected to a faucet. However, it is difficult to use the joint to connect the longitudinally extensible hose to a conventional hose or faucet. Moreover, the longitudinally extensible hose could easily be worn or broken during the connection to the hose or faucet.

The present invention is therefore intended to obviate or at least alleviate the problems encountered in prior art.

### SUMMARY OF INVENTION

It is the primary objective of the present invention to provide a joint for connection to an internal tube of a longitudinally extensible hose.

To achieve the foregoing objective, the joint includes a sleeve and a tubular insert. The sleeve includes an axial channel for receiving the internal tube. The axial channel includes a diameter-wise smaller section and a diameter-wise larger section. The tubular insert is inserted in the internal tube so that the tubular insert and the sleeve clamp the internal tube. The tubular insert includes an axial passageway, an annular bulge and an annular flange. The axial passageway extends coaxially with the axial channel. The annular bulge is formed on a middle section of the tubular insert and adapted for pressing the internal tube against an wall of the diameter-wise larger section of the axial channel. The annular flange is formed at an end of the tubular insert and adapted for contact with an end of the sleeve.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a longitudinally extensible hose and a joint assembly according to the preferred embodiment of the present invention;

FIG. 2 is an exploded view of the joint assembly shown in FIG. 1;

FIG. 3 is an enlarged partial view of the joint assembly of FIG. 2; and

FIG. 4 is a cross-sectional view of the joint assembly shown in FIG. 1.

### DETAILED DESCRIPTION OF PREFERRED EMBODIMENT

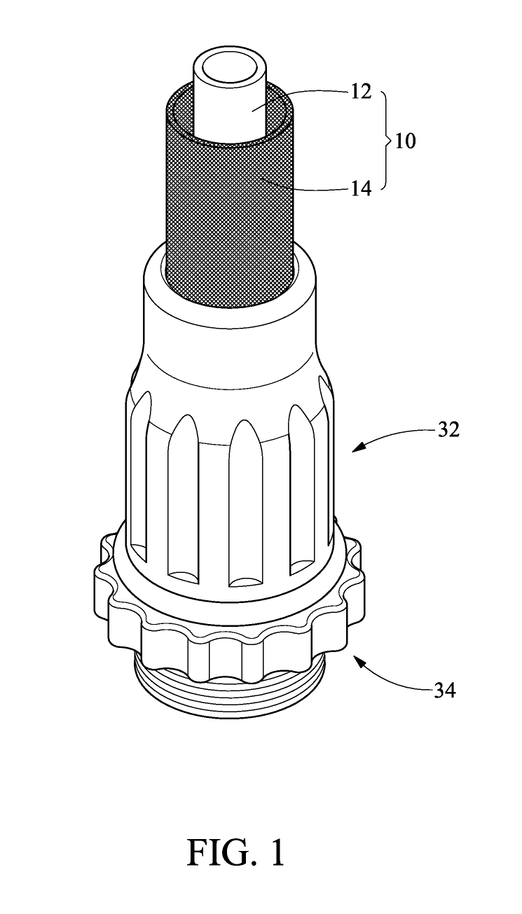

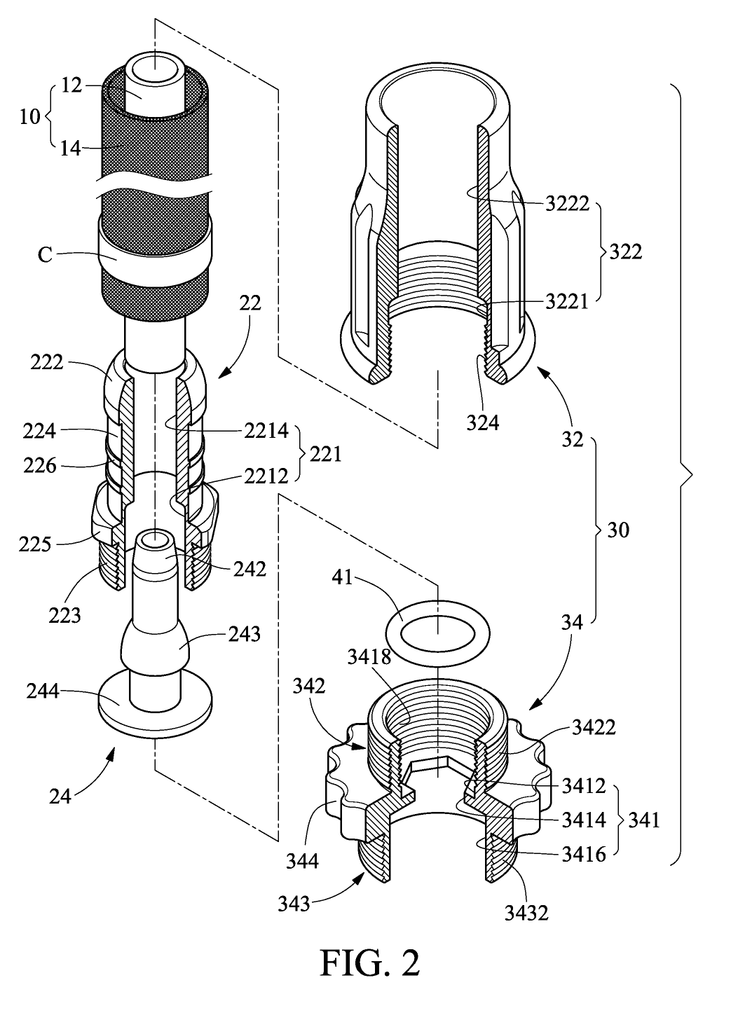

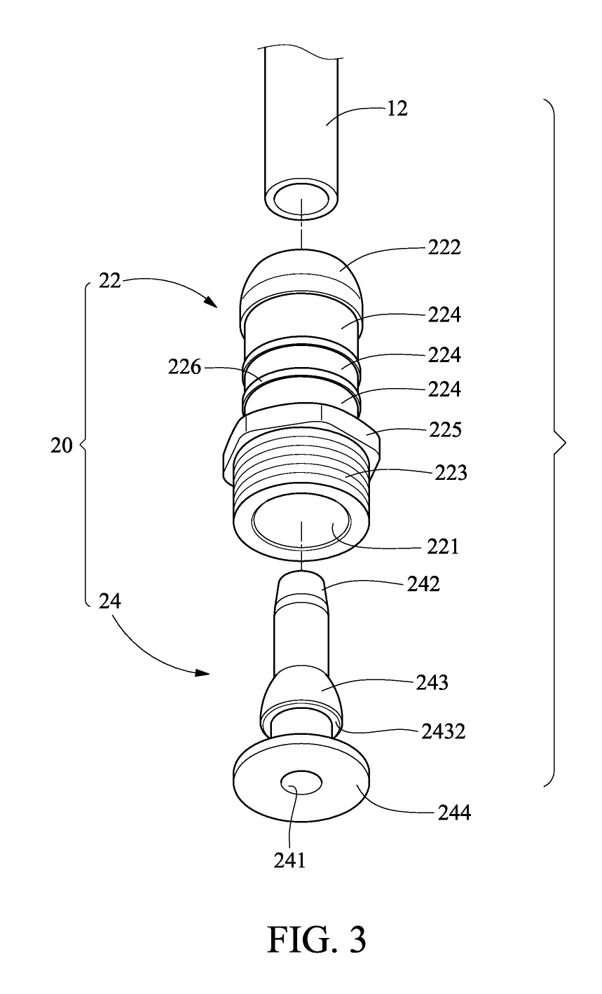

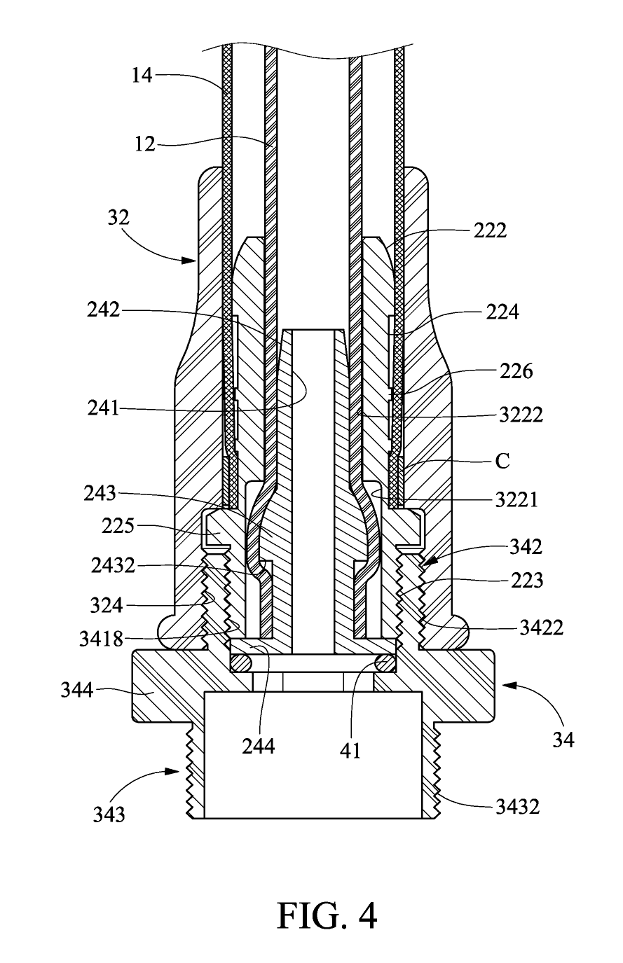

Referring to FIGS. 1 through 4, a longitudinally extensible hose 10 is provided with a joint assembly according to the preferred embodiment of the present invention. The joint assembly includes first joint 20 and second joint 30.

The longitudinally extensible hose 10 includes an elastic internal tube 12 inserted in a woven external tube 14. The longitudinally extensible hose 10 is conventional and will not be described in detail.

The first joint 20 is used to connect a terminal section of the internal tube 12 to a terminal section of the external tube 14. The first joint 20 includes a sleeve 22 and a tubular insert 24.

The sleeve 22 includes an axial channel 221, a guiding section 222, a thread 223, annular grooves 224 and an annular flange 225. The axial channel 221 axially extends throughout the sleeve 22. The axial channel 221 receives the internal tube 12 in use. The axial channel 221 includes a diameter-wise larger section 2212 and a diameter-wise smaller section 2214, with an annular shoulder formed between them.

The guiding section 222 and the thread 223 are formed on an external face of the sleeve 22, near two ends of the sleeve 22. The guiding section 222 is in the form of a conical frustum. The guiding section 222 is used to facilitate insertion of the sleeve 22 into the external tube 14.

The annular flange 225 is formed on the external face of the sleeve 22, next to the thread 223. The annular grooves 224 are made in the external face of the sleeve 22, between the guiding section 222 and the annular flange 225. The annular grooves 224 are separated from one another by annular ribs 226 that extend on the external face of the sleeve 22. The annular grooves 224 are used to facilitate the insertion of the external tube 14 in the sleeve 22 reducing friction between an internal face of the external tube 14 and the external face of the sleeve 22. In addition to the annular grooves 224 and annular ribs 226, a ferrule C can be used to keep the external tube 14 on the sleeve 22. The ferrule C presses a section of the external tube 14 in one of the annular grooves 224.

The tubular insert 24 is inserted in the tell final section of the internal tube 12, which is inserted in the diameter-wise larger section 2212 of the axial channel 221. Thus, the terminal section of the internal tube 12 is clamped by and between the tubular insert 24 and the sleeve 22. The tubular insert 24 includes axial passageway 241, a guiding section 242, an annular bulge 243 and an annular flange 244.

The axial passageway 241 axially extends throughout the tubular insert 24.

The guiding section 242 and the annular flange 244 are formed on an external face of the tubular insert 24, near two ends of the tubular insert 24. The guiding section 242 is in the form of a conical frustum. In radial manner, the annular flange 244 extends from the external face of the tubular insert 24. The guiding section 242 is used to facilitate insertion of the tubular insert 24 in the terminal section of the internal tube 12. The annular flange 244 is used to abut against an end of the internal tube 12 and an end of the sleeve 22 so that they are flush with each other.

In a radial manner, the annular bulge 243 extends from the external face of the tubular insert 24, between the guiding section 242 and the annular flange 244. The diameter of the annular bulge 243 gets larger in a sense of direction toward the annular flange 244. The annular bulge 243 includes an end face 2432 that extends perpendicular to the axis of the tubular insert 24. The end face 2432 is used to keep the tubular insert 24 in the internal tube 12.

The second joint 30 is used to receive the terminal section of the internal tube 12 and the tell final section of the external tube 14. The second joint 30 and the first joint 20 clamp the terminal section of the external tube 14. The second joint 30 includes a sleeve 32 and a collar 34.

The sleeve 32 is provided around the terminal section of the internal tube 12, the terminal section of the external tube 14 and the first joint 20. The sleeve 32 includes an external tube axial passageway 322 and a thread 324 formed on the wall of the axial passageway 322.

The axial passageway 322 axially extends throughout the sleeve 32. The axial passageway 322 is used to receive the terminal section of the internal tube 12, the terminal section of the external tube 14, and the first joint 20. The axial passageway 322 includes a diameter-wise larger section 3221 and a diameter-wise smaller section 3222, with an annular shoulder formed between them. The annular flange 225 of the sleeve 22 is inserted in the diameter-wise larger section 3221 of the axial passageway 322 and located against the annular shoulder formed between the sections 3221 and 3222.

The thread 324 extends on the wall of the diameter-wise larger section 3221 of the axial passageway 322.

The collar 34 includes an axial passageway 341, an engaging section 342, a connecting section 343 and an annular flange 344.

The axial passageway 341 axially extends throughout the collar 34. The axial passageway 341 includes first, second and third sections 3412, 3414 and 3416 among which the second section 3414 is given the smallest diameter and the third section 3416 is given the largest diameter. Thus, an annular shoulder is formed between the first section 3412 and the second section 3414, and another annular shoulder is formed between the second section 3414 and the third section 3416. There is a thread 3418 formed on the wall of the first section 3412. The thread 3418 of the collar 34 is engaged with the thread 223 of the sleeve 22 so that the annular shoulder formed between the first section 3412 and the second section 3414 presses the annular flange 244 of the tubular insert 24 against an end of the sleeve 22 near the thread 223.

Moreover, for sealing, an O-ring 41 is located between the annular flange 244 and the annular shoulder formed between the first section 3412 and the second section 3414 of the axial passageway 341.

The engaging section 342 and the connecting section 343 are formed near two opposite ends of the collar 34. The engaging section 342 includes a thread 3422 extending an external face thereof. The thread 3422 is engaged with the thread 324 of the sleeve 32. Preferably, the connecting section 343 includes a thread 3432 formed on an external face thereof. The thread 3432 is engageable with a thread formed on an accessory (not shown).

The annular flange 344 is formed on the external face of the collar 34, between the engaging section 342 and the connecting section 344.

As described above, the internal tube 12 is restrained by the sleeve 22 and tubular insert 24 of the first joint 20. The external tube 14 is restrained by the ferrule C and clamped by the sleeves 22 and 32. The internal tube 12 is restrained independent of the external tube 14. Thus, when the external tube 14 is pulled, the internal tube 12 will not be pulled, i.e., the internal tube 12 will not be disengaged from a faucet.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A joint for connection to an internal tube (12) of a longitudinally extensible hose (10), wherein the joint comprises:
a sleeve (22) comprising an axial channel (221) for receiving the internal tube (12), wherein the axial channel (221) comprises a diameter-wise smaller section (2212) and a diameter-wise larger section (2214); and
a tubular insert (24) inserted in the internal tube (12) so that the tubular insert (24) and the sleeve (22) clamp the internal tube (12), wherein the tubular insert (24) comprises:
an axial passageway (241) extending coaxially with the axial channel (221);
an annular bulge (243) formed on a middle section of the tubular insert (24) and adapted for pressing the internal tube (12) against an wall of the diameter-wise larger section (2214) of the axial channel (221); and
an annular flange (244) formed at an end of the tubular insert (24) and adapted for contact with an end of the sleeve (22).

2. The joint according to claim 1, wherein the sleeve (22) further comprises:
a guiding section (222) formed near an end of the sleeve (22);
a thread (223) formed near an opposite end of the sleeve (22);
an annular flange (225) formed next to the thread (223); and
an annular groove (224) made between the guiding section (222) and the annular flange (225).

3. The joint according to claim 1, wherein the annular bulge (243) is given a diameter that gets larger in a sense of direction toward the thread (223) and comprises an end face (2432) extending perpendicular to an axis of the sleeve (22).

4. The joint according to claim 3, wherein the tubular insert (24) further comprises a guiding section (242) formed near an opposite end.

5. A joint assembly for connecting an internal tube (12) to an external tube (14) of a longitudinally extensible hose (10), wherein the joint assembly comprises:
a first joint (20) comprising:
a sleeve (22) comprising:
an axial channel (221) comprising a diameter-wise smaller section (2212) and a diameter-wise larger section (2214);
a thread (223) formed near an end of the sleeve (22);
an annular groove (224); and
an annular flange (225) formed between the thread (223) and the annular groove (224);
a tubular insert (24) inserted in the internal tube (12) so that the tubular insert (24) and the sleeve (22) clamp the internal tube (12), wherein the tubular insert (24) comprises:
an axial passageway (241) extending coaxially with the axial channel (221);
an annular flange (244) formed at end of the tubular insert (24) and adapted for abutment against an end of the sleeve (22); and
an annular bulge (243) formed on a middle section of the tubular insert (24) and adapted for pressing the internal tube (12) against a wall of the diameter-wise larger section (2214) of the axial channel (221); and
a second joint (30) comprising:
a sleeve (32) located around the external tube (14) and the sleeve (22) of the first joint (20), and comprising:
an axial passageway (322) extending coaxially with the axial channel (221), and comprising a diameter-wise larger section (3221) and a diameter-wise smaller section (3222), wherein the diameter-wise smaller section (3222) of the axial passageway (322) of the sleeve (32) of the second joint (10) receives the external tube (14); and
a thread (324) formed on a wall of the diameter-wise larger section (3221) of the axial passageway (322) of the sleeve (32); and
a collar (34) comprising:
an axial passageway (341) extending coaxially with the axial passageway (322) of the sleeve (32) of the second joint (30);
a thread (3418) formed on a wall of the axial passageway (341) of the collar (34) and engaged with the thread (223) of the sleeve (22) of the first joint (20);
an engaging section (342) formed near an end of the collar (34), and comprising a thread (3422) engaged with the thread (324) of the sleeve (32) of the second joint (30);
a connecting section (343) formed near an opposite end of the collar (34); and
an annular flange (344) formed between the engaging section (342) and the connecting section (344) and located against an end of the sleeve (32) of the second joint (30).

6. The joint according to claim 5, further comprising a ferrule (C) for pressing the external tube (14) against the sleeve (22) of the first joint (20).

7. The joint according to claim 6, wherein the ferrule (C) presses a section of the external tube (14) into the annular groove (224) of the sleeve (22) of the first joint (20).

8. The joint according to claim 5, wherein the sleeve (22) further comprises a guiding section (222) formed near an opposite end.

9. The joint according to claim 5, wherein the tubular insert (24) further comprises a guiding section (242) formed near an opposite end.

10. The joint according to claim 5, wherein the connecting section (343) comprises a thread (3432) formed thereon.

11. The joint according to claim 5, wherein the axial passageway (341) comprises first, second and third sections (3412, 3414, 3416) among which the second section (3414) is made with the smallest diameter and the third section (3416) is made with the largest diameter, wherein the collar (34) further comprises a thread (3418) formed on a wall of the first section (3412) and engaged with the thread (223) of the sleeve (22) of the first joint (20).

12. The joint according to claim 10, further comprising an O-ring (41) inserted in the first section (3412) of the axial passageway (341) of the collar (34).
